(19) United States
(12) Patent Application Publication
(10) Pub. No.: US 2004/0104563 A1
(43) Pub. Date: Jun. 3, 2004

(54) Gas bag module for a vehicle occupant restraint system

(76) Inventor: Anton Fischer, Leinweiler (DE)

Correspondence Address: Tarolli & Sundheim Covell, Tummino & Szabo, Suite 1111, 526 Superior Avenue, Cleveland, OH, 44114-1400, US

(21) Appl. No.: 10/473,657

(22) PCT Filed: Apr. 2, 2002
(86) PCT No.: PCT/EP02/03639

(30) Foreign Application Priority Data
Apr. 2, 2001 (DE) 201 05 734.4

(51) Int. Cl. B60R 21/16

(52) U.S. Cl. 280/743.1

(57) ABSTRACT

A gas bag module for a vehicle occupant restraint system, comprising a gas bag (12) and an elongated gas generator (14), which projects by a section (18) into the gas bag (12), includes a mounting (16) for the gas generator (14), extending along a substantial portion of the axial length of the gas generator (14). A part (26) of the mounting (16) projects into the gas bag (12) and at least partly surrounds the section (18) of the gas generator (14) projecting into the gas bag (12). A part of the mounting (16) extending outside the gas bag (12) has fastening elements (30) for fastening to a vehicle part.

### FIELD OF THE INVENTION

The invention relates to a gas bag module for a vehicle occupant restraint system.

### BACKGROUND OF THE INVENTION

Gas bag modules normally comprise a gas bag and an elongated gas generator which has a section that projects into the gas bag. In order to fill the gas bag of a vehicle occupant restraint system quickly in an emergency, the hot gas generated by the gas generator is often directed through special gas ducts into the gas bag. These gas ducts also serve to protect the gas bag fabric from the hot gases. Of course, special gas ducts make the production of the gas bag module more expensive.

It is therefore, an object of the invention to provide a simple and favorably-priced gas bag module, in which a reliable and rapid inflation of the gas bag is ensured.

### BRIEF SUMMARY OF THE INVENTION

According to the invention, a gas bag module for a vehicle occupant restraint system comprises a gas bag and an elongated gas generator which has a section that projects into the gas bag. The module further comprises a mounting for the gas generator which extends along a substantial portion of an axial length of the gas generator. A first part of the mounting projects into the gas bag and at least partly surrounds the section of the gas generator which projects into the gas bag. A second part of the mounting extends outside the gas bag and carries fastening elements for fastening to a vehicle part. The first part of the mounting, namely the part which projects into the gas bag, can fulfill various tasks. Thus, for example, it can be used for fixing the gas generator in the mounting. However, it can also fulfill the function of a gas duct and protect from damage by hot gas the parts of the wall of gas bag which lie in the immediate vicinity of the gas generator. The particular design of the mounting therefore allows the gas bag module to be able to be adapted in a very flexible manner to various purposes of use. As neither a separate gas duct nor a housing for the gas generator are required, savings can be made with regard to components which would make the production of the gas bag module more expensive.

The first part of the mounting preferably protects wall parts of the gas bag from being directly impinged by hot gas from the gas generator, so that damage especially to those parts of the gas bag can be avoided which are arranged in the direct vicinity of the gas generator at the start of the unfolding of the gas bag.

In a preferred embodiment of the invention, some of the outflow openings of the gas generator are closed off by the first part of the mounting, i.e. the part which projects into the gas bag. This embodiment is advantageous in particular because a known gas generator can be used which is neutral with regard to thrust and the outflow openings of which are arranged such that the thrust caused by emerging gas is zero.

In another preferred embodiment of the invention, the first part of the mounting is radially spaced apart from the gas generator. In this way, gas can flow out from all outflow openings of the gas generator, in order to quickly make available the necessary quantity of gas to fill the gas bag. As the proportion of the gas which emerges from the outflow openings which are oriented to the part of the mounting arranged in the interior of the gas bag, is deflected at the mounting, there is still no risk of damage to the gas bag walls.

Preferably the gas bag is a side gas bag covering side windows of a vehicle. The gas generator is arranged approximately in the center of the gas bag as related to a main direction of extent of the gas bag, preferably at the upper edge of the gas bag. Since the first part of the mounting deflects the outflow direction of the gas from the gas generator perpendicularly to the longitudinal axis thereof into the interior of the gas bag, this arrangement allows to fill a gas bag quickly and uniformly.

For reasons of simple and favorably-priced manufacture, the mounting is preferably made from sheet metal.

Advantageously the gas bag has an opening through which the section of the gas generator projects into the gas bag, and the rim of the opening is fastened with a clip to the mounting and to the gas generator. In this way, the gas bag and the gas generator can be fastened simply and securely to the mounting at the same time.

In a further advantageous embodiment of the invention, the gas bag is provided with a protective layer, which keeps the stream of gas, flowing out from the gas generator, from direct contact with walls of the gas bag. The protective layer deflects the gas stream preferably through approximately 90 degrees. Preferably, the protective layer is constructed in one piece. In combination with the special mounting of the gas generator, damage to the gas bag by the hot gas can be avoided in a simple and cost-effective way.

Further advantageous features of the invention are set out in the dependent claims.

### BRIEF DESCRIPTION OF THE DRAWINGS

FIG. 1 shows a partial view of a gas bag module according to the invention;

FIGS. 2a-c show in a sectional view along the line I-I of FIG. 1 various arrangements of a protective layer in a gas bag module according to the invention;

FIG. 3 shows a schematic view of a protective layer for use in a gas bag module according to the invention;

FIGS. 4 and 5 show schematic sectional views along the line A-A and B-B, respectively, of FIG. 3 in a first variant of the protective layer; and

FIGS. 6 and 7 show schematic sectional views along the line A-A and B-B, respectively, of FIG. 3 in a second variant of the protective layer.

### DETAILED DESCRIPTION OF PREFERRED EMBODIMENTS OF THE INVENTION

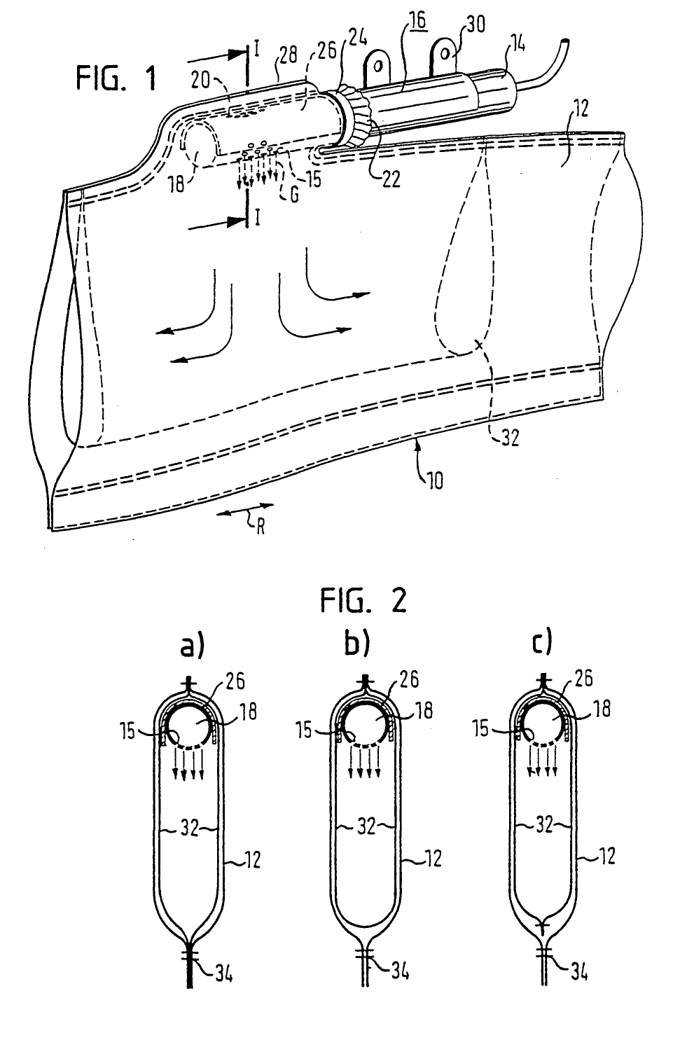

The gas bag module 10 illustrated in FIG. 1 contains a side gas bag 12, which preferably extends from the A-column to the C-column of a vehicle, in order to cover side windows. In addition, the module contains a gas generator 14, which preferably is an elongated tubular gas generator, constructed so as to be neutral with respect to thrust, with outflow openings 15 arranged along its peripheral surface. The gas bag module 10 also contains a mounting 16 which extends along the gas generator 14.

The gas generator 14 projects with a section 18 through an opening of the gas bag 12 into the gas bag 12. The section 18 is advantageously selected to be so long that all the outflow openings 15 of the gas generator 14 are situated inside the gas bag 12.

The mounting 16 extends over a major part of the axial length of the gas generator 14, in the embodiment shown approximately over four fifths of the length of the gas generator 14. A first part 26 of the mounting 16 projects through the opening into the gas bag 12. A clip 24 fastens the rim 22 of the opening of the gas bag both to the mounting 16 and also to the gas generator 14. The part 26 is bent in a U-shape and arranged between the gas generator 14 and the upper edge 28 of the gas bag 12. The length of the part 26 corresponds approximately to the length of the section 18 of the gas generator.

The first part 26 of the mounting 16 covers some of the outflow openings 15 of the gas generator 14, so that on activation of the gas generator 14 gas can only emerge from the outflow openings 15 facing the interior of the gas bag. The first part 26 of the mounting 16 rests directly against the section 18 of the gas generator 14, in order, in addition to its protective function, to achieve a good fixing of the gas generator 14 in place in the mounting 16.

A second part of the mounting 16 is located outside the gas bag 12 and has two tongue-shaped fastening elements 30, by which the mounting and hence the gas generator 14 can be fastened to a vehicle part not shown. As the mounting 16 embraces the gas generator 14 at least in sections, a fastening of the gas generator 14 to the mounting 16 via the clip 24 is sufficient. However, further fastening elements can also be provided, in order to fasten the gas generator 14 to the mounting 16.

The gas generator 14 is arranged approximately in the center of the upper edge 28 of the gas bag 12, as related to the main direction of extent R of the gas bag. The gas generator 14 is arranged approximately parallel to the main direction of extent R.

In an alternative embodiment which is not illustrated, a small radial distance can be provided between the first part of the mounting projecting into the gas bag and the outflow openings of the gas generator, so that gas can flow out from all outflow openings. A proportion of the gas is then deflected on that part of the mounting and the gas stream is directed in the direction of the arrow into the interior of the gas bag.

In the embodiment which is shown, in addition a protective layer 32 of textile material is arranged in the gas bag 12. The protective layer 32 can extend over a considerable portion in the main direction of extent R of the gas bag 12. The protective layer 32 is preferably made in one piece and fixed at the upper edge 28 of the gas bag 12. As is shown in FIG. 2a, the protective layer 32 can in addition be fastened to the lower edge 34 of the gas bag 12. Alternatively, the protective layer 32 can also, as shown in FIG. 2c, consist of two pieces sewn together in the region of the lower edge of the gas bag 12.

The protective layer 32 deflects the hot gas stream G, flowing out from the gas generator 14, through approximately 90 degrees into the main direction of extent and divides it. The protective layer 32 also prevents the walls of the gas bag 12 from being directly impinged and damage to the gas bag is prevented.

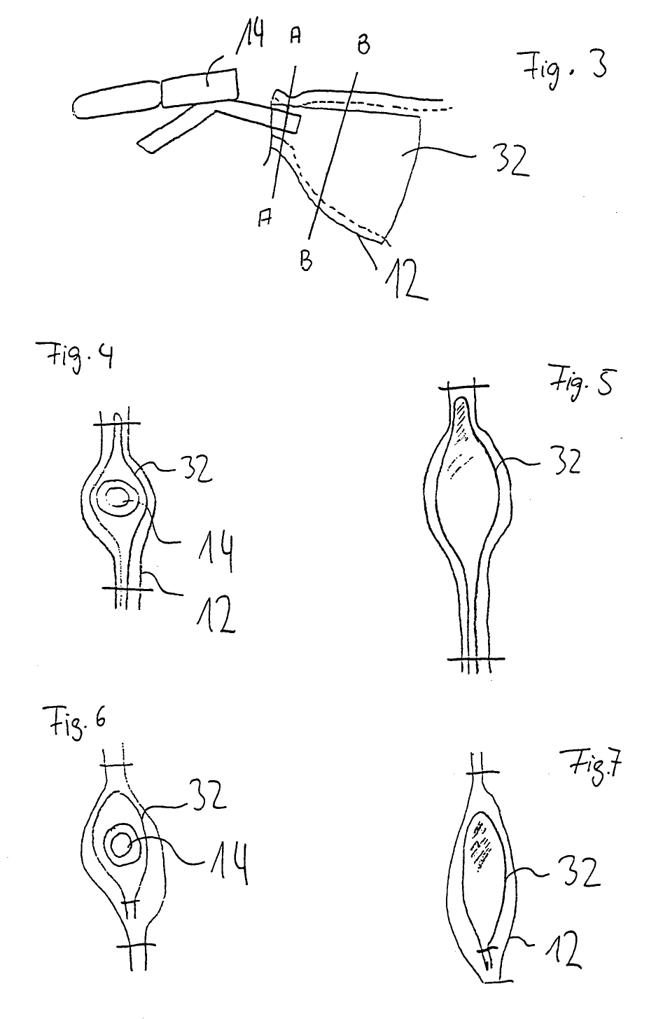

Such a protective layer 32 is further intended to avoid, if possible, that hot gas comes into contact with the seams of the gas bag 12. FIGS. 3 to 7 illustrate possible variants of arranging the protective layer 32. The protective layer 32 forms a tube which extends from the gas generator into the interior of the gas bag 12. For protecting the seam which is at the top when the gas bag is in the fitted condition, in the example shown in FIGS. 4 and 5 the protective layer 32 is not connected with the gas bag 12 in the region of the upper seam. In the region of the gas generator, provision may be made for a connection with the gas bag.

It is however also feasible not to connect the protective layer 32 with the gas bag at all, as illustrated in FIGS. 6 and 7, but to fasten it only to the gas generator or its mounting, for example. This provides protection for all seams of the gas bag in the region of the protective layer 32.

1. A gas bag module for a vehicle occupant restraint system, comprising a gas bag (12) and an elongated gas generator (14) which projects by a section (18) into the gas bag (12), characterized in that a mounting (16) extending along a substantial portion of the axial length of the gas generator (14) is provided for the gas generator (14), a part (26) of the mounting (16) projecting into the gas bag (12) and at least partly surrounding the section (18) of the gas generator (14) projecting into the gas bag (12), and a part of the mounting (16) extending outside the gas bag (12) having fastening elements (30) for fastening to a vehicle part.

2. The gas bag module according to claim 1, characterized in that the part (26) of the mounting (16) projecting into the gas bag (12) protects wall parts of the gas bag (12) from being directly impinged by a hot gas stream (G) from the gas generator (14).

3. The gas bag module according to claim 2, characterized in that the part (26) of the mounting (16) projecting into the gas bag (12) is radially spaced apart from the gas generator (14).

4. The gas bag module according to any of the preceding claims, characterized in that the gas generator (14) is constructed so as to be neutral with respect to thrust.

5. The gas bag module according to any of the preceding claims, characterized in that part of the outflow openings (15) of the gas generator (14) are closed off by the part (26) of the mounting (16) projecting into the gas bag (12).

6. The gas bag module according to any of the preceding claims, characterized in that the gas bag is a side gas bag covering side windows of a vehicle, and the gas generator (14) is arranged approximately in the middle of the gas bag (12) as related to a main direction of extent (R) of the gas bag (12).

7. The gas bag module according to any of the preceding claims, characterized in that the gas bag (12) has an opening through which the section (18) of the gas generator (14) projects into the gas bag (12) and that the rim (22) of the opening is fastened with a clip (24) to the mounting (16) and to the gas generator (14).

8. The gas bag module according to any of the preceding claims, characterized in that the gas bag (12) is provided with a protective layer (32) which keeps a hot gas stream (G) from direct contact with walls of the gas bag (12).

9. The gas bag module according to claim 8, characterized in that the protective layer (32) deflects the gas stream (G) through approximately 90°.

10. The gas bag module according to any of the preceding claims, characterized in that the gas bag (12) is a side gas bag which extends substantially from an A-column to a C-column of a vehicle.
